(19) United States
(12) Patent Application Publication
(10) Pub. No.: US 2026/0341674 A1
(43) Pub. Date: Oct. 29, 2026

(54) RECHARGEABLE THERMAL BATTERY

(71) Applicant: National Technology & Engineering Solutions of Sandia, LLC, Albuquerque, NM (US)

(72) Inventors: David Herman, Albuquerque, NM (US); Daniel Edward Wesolowski, Albuquerque, NM (US); Aaron David Melad, Albuquerque, NM (US); Eric Koederitz Allcorn, Albuquerque, NM (US); Noah Benjamin Schorr, Albuquerque, NM (US); Christine Cardinal Roberts, Albuquerque, NM (US); Kyle R. Fenton, Albuquerque, NM (US); Mohan Pramod Karulkar, Albuquerque, NM (US); Martin Nemer, Albuquerque, NM (US)

(21) Appl. No.: 19/240,135

(22) Filed: Jun. 17, 2025

Related U.S. Application Data
(63) Continuation-in-part of application No. 18/410,357, filed on Jan. 11, 2024.

(51) Int. Cl. H01M 4/134; H01M 4/136; H01M 50/403; H01M 50/434

(52) U.S. Cl. CPC H01M 4/134; H01M 4/136; H01M 50/403; H01M 50/434

(57) ABSTRACT

A rechargeable thermal battery including solid electrolyte separator, a lithium based anode, and iron disulfide cathode. The solid electrolytes materials may include lithium garnets and the lithium based anode may include LiB. The lithium garnets may include Li₇La₃Zr₂O₁₂ (LLZO) and Li_{6.4}La₃Zr_{1.4}Ta_{0.6}O₁₂ (LLZTO).

### CROSS-REFERENCE TO RELATED APPLICATION

This application is a Continuation-in-Part of U.S. patent application Ser. No. 18/410,357, filed Jan. 11, 2024, and entitled “THERMALLY ACTIVATED SOLID ELECTROLYTE BATTERY,” which is incorporated herein by reference in its entirety.

### STATEMENT OF GOVERNMENT INTEREST

This invention was made with Government support under Contract No. DE-NA0003525 awarded by the United States Department of Energy/National Nuclear Security Administration. The Government has certain rights in the invention.

### TECHNICAL FIELD

The present invention relates to rechargeable battery systems.

### BACKGROUND

Lithium battery systems and thermal batteries have many limitations due to the interactions between anodes, cathodes, and electrolytes employed in such batteries. Such interactions can cause unreversible phase changes limiting the usability/capacities of such battery systems including their potential for recharging. Preventing such interactions may require the use of anode and cathode materials that provide less than desired or possible capacities (energy density and specific energy). The present invention addresses many of those limitations.

### SUMMARY

Embodiments include a rechargeable thermal battery including solid electrolytes that provide advantages over molten salt electrolyte-based batteries including number of rechargeable cycles due to the stability of the solid electrolyte, with cathodes and anodes. Embodiments that include a rechargeable battery with solid electrolytes has dimensional stability, electrochemical stability, a high degree of manufacturability and reproducibility, and strong temperature-dependent ionic conductivity. The strong temperature dependent ionic conductivity also enables long-term storage at low-temperatures, provides state-of-health assessment at intermediate temperatures, and operation at high temperatures. Rechargeable battery solid electrolytes materials may include lithium garnets.

An embodiment of the invention may include a rechargeable thermal battery system. The rechargeable thermal battery system may include a lithium based anode, a lithium garnet based separator, and an iron disulfide based cathode. In an embodiment, the lithium garnet separator consists primarily of one of Li7La3Zr2O12 and Li6.4La3Zr1.4Ta0.6O12 (LLZTO). In an embodiment, the separator may consist primarily of Li6.4La3Zr1.4Ta0.6O12 (LLZTO). Further, the anode may consist primarily of one of Lithium metal matrix, LiB, LiSi, and LiFe in an embodiment. In an embodiment, the anode may consist primarily of LiB. Further, the anode may consist primarily of Lithium metal matrix. In an embodiment, the cathode may consist primarily of one of FeS₂, FeS₂+LiCl—KCl LiFe, FeS₂+LLZTO, and CoS₂. In an embodiment, the cathode may consist primarily of FeS₂.

In an embodiment, the anode may become substantially liquid when in operation. Further, the rechargeable thermal battery system may include a heat source. In addition, the separator may be formed in part via sintering. In another embodiment, the anode may be formed from LiB foil.

### BRIEF DESCRIPTION OF THE DRAWINGS

The drawings illustrate several embodiments of the invention, wherein identical reference numerals refer to identical or similar elements or features in different views or embodiments shown in the drawings. The drawings are not to scale and are intended only to illustrate the elements of various embodiments of the present invention.

FIG. 1A is a simplified diagram of battery architecture in accordance with one or more embodiments of the present invention may be employed.

FIG. 1B is a simplified schematic of an Li/FeS₂ rechargeable thermal battery design, with an LLZO solid state electrolyte separator in accordance with one or more embodiments of the present invention may be employed.

FIG. 2A is a simplified diagram of the various configurations of primary active components of a battery system in accordance with one or more embodiments of the present invention.

FIGS. 2B-2H and 3A-3D are simplified diagrams of various configurations/combinations of primary active components of a battery system in accordance with one or more embodiments of the present invention.

FIG. 4A is a graph of discharged cell capacity at 450 °C for a rechargeable thermal battery configuration LiB/LLZTO/FeS2+LiCl—KCl cell (blue) shown in FIG. 3A-3D compared to a conventional thermal battery cell with a molten salt electrolyte (green) in accordance with one or more embodiments of the present invention.

FIG. 4B is a voltage plot of multiple cycles for a rechargeable thermal battery configuration having a tantalum-doped LLZO sintered pellet separator with charge and discharge at 200 mA/cm² in accordance with one or more embodiments of the present invention.

### DETAILED DESCRIPTION

Battery systems ideally are reversable and provide long-term energy storage, high energy density, and high specific energy under certain environmental conditions. To achieve these features: reversibility, long-term energy storage, high energy density and specific energy under certain environmental conditions, a battery system needs to be electrochemically, thermally, and kinetically stable on timescales, cycle numbers, and environmental conditions relevant to a battery's intended use. Fundamental to battery system operation is the compatibility of primary active components: the anode, cathode, and electrolyte(s).

To achieve some of the desired features, thermal batteries have been developed that provide long-term energy storage and operate at high temperatures (about 350-550 C) when activated. Thermal batteries are generally lithium-based batteries where their components may include Li(Si) alloy anodes, FeS2 (known as Pyrite or iron disulfide) cathodes, and molten salts such as LiCl—KCl eutectic electrolyte bound in MgO. Lithium provides several desirable features: high energy density W-hr/m3, and high specific energy W-hr/kg. Some lithium based thermal batteries are one use only (not reversable, rechargeable, or multi-cycle) and have decreased deliverable capacity due to parasitic reactions between its components when activated. Alternatively, standard lithium-ion batteries that may include graphite anodes, NMC (LiNiₓMn_{y}Co_{z}O₂) cathodes and carbonate-based liquid electrolytes that experience significant capacity fade at temperatures greater than 60 °C.

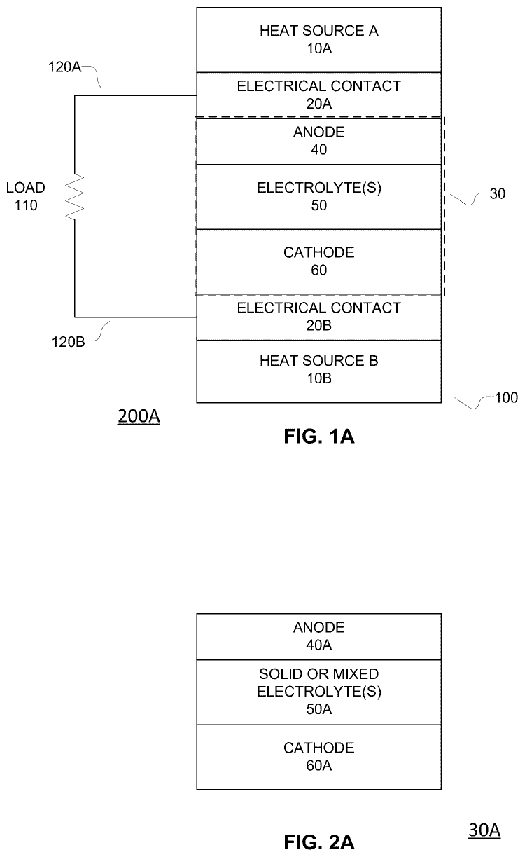

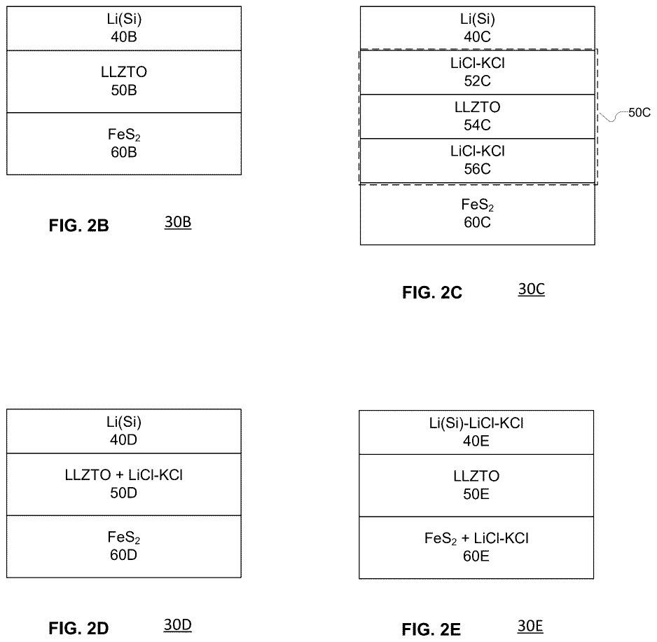

A battery system may ideally have several other desirable features including low vapor pressure, high ionic conductivity when active, limited interaction between electrolyte and electrode materials, low solubility of anode, cathode, and discharge products, thermal stability at desired operational temperatures, and mechanical stability. FIG. 1A is a simplified diagram of battery architecture 200A in accordance where one or more embodiments of a battery system 100 of the present invention may be employed. As shown in FIG. 1A, battery architecture 200A includes a battery system 100 coupled to a load 110 via electrical conductors/leads 120A, 120B.

In an embodiment, the battery system 100 includes active components 30, electrical contacts 20A, 20B and one or more heats sources 10A, 10B. The battery system 100 active or electrical energy generation components 30 may include an anode 40, cathode 60, and electrolyte(s) 50 separating the anode 40 and cathode 60. An electrical contact 20A, 20B comprised of an electrically conducting material such as stainless steel in an embodiment and may be electrically coupled to the anode 40 and cathode 60, respectively. The heat sources 10A, 10B may generate heat when energized to activate or more functionally activate one or more components 30. A heat source 10A, 10B may chemically or electrically provide heat energy when activated including via pyrotechnic ignitor or application of electrical energy. The battery system 100 may have a single heat source 10A, 10B in an embodiment.

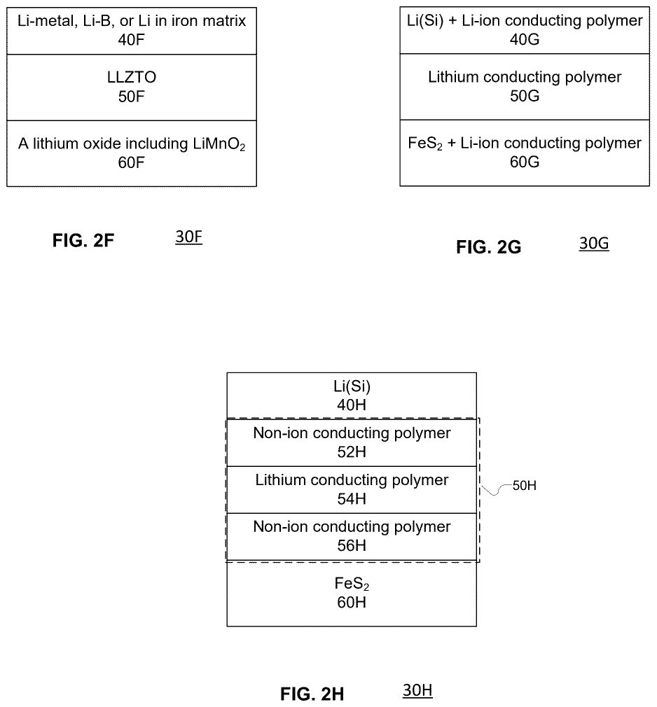

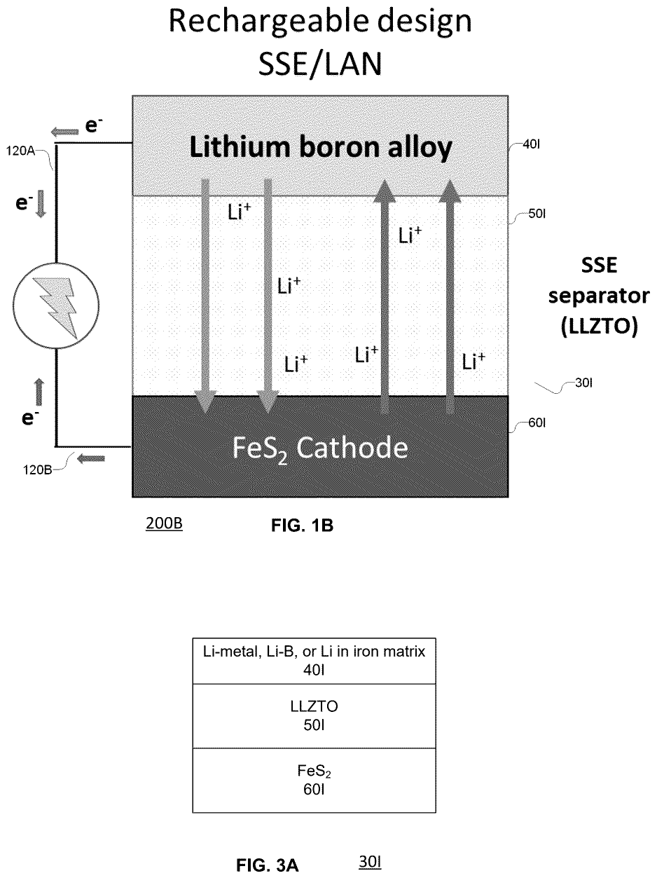

FIG. 2A is a simplified diagram of the primary active or electrical energy generation components 30A of a battery system 100 in accordance with one or more embodiments of the present invention. FIGS. 2B-2H and 3A-3D are simplified diagrams of the various combinations of primary active or electrical energy generation components 30B-30L of a battery system 100 in accordance with one or more embodiments of the present invention. In the embodiments shown in FIGS. 2A-2H and 3A-3D, each of the active or electrical energy generation components 30A-30L electrolytes 50A-50L include some solid or polymer electrolytes. As shown in FIG. 2A, the active or electrical energy generation components 30A include an anode 40A and a cathode 60A separated by a solid electrolyte or electrolyte mixed with solid electrolytes 50A. In an embodiment, the solid electrolytes ionic activity may increase with temperature. In an embodiment, the solid electrolyte may provide some limited ionic activity even at room temperature or other temperature below the intended full operational temperature, enabling a battery system 100 including such an electrolyte to be tested/operationally verified periodically while not depleting the battery system 100.

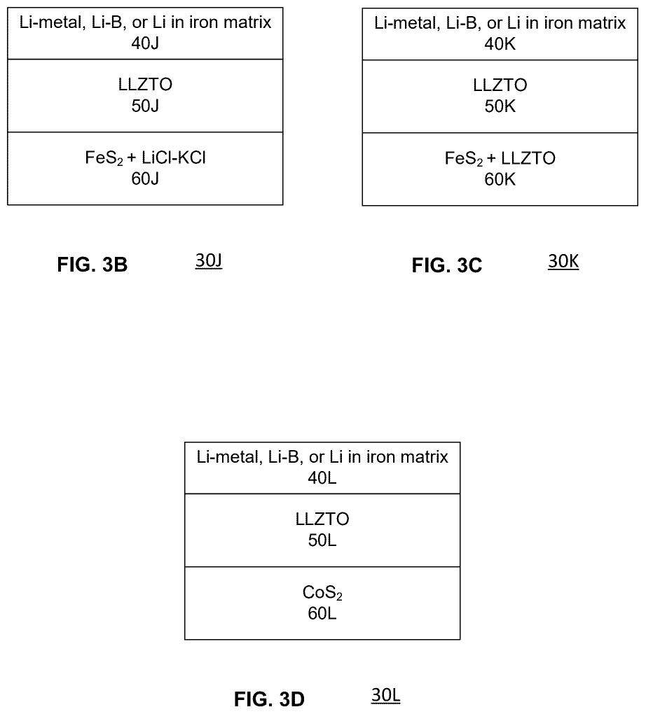

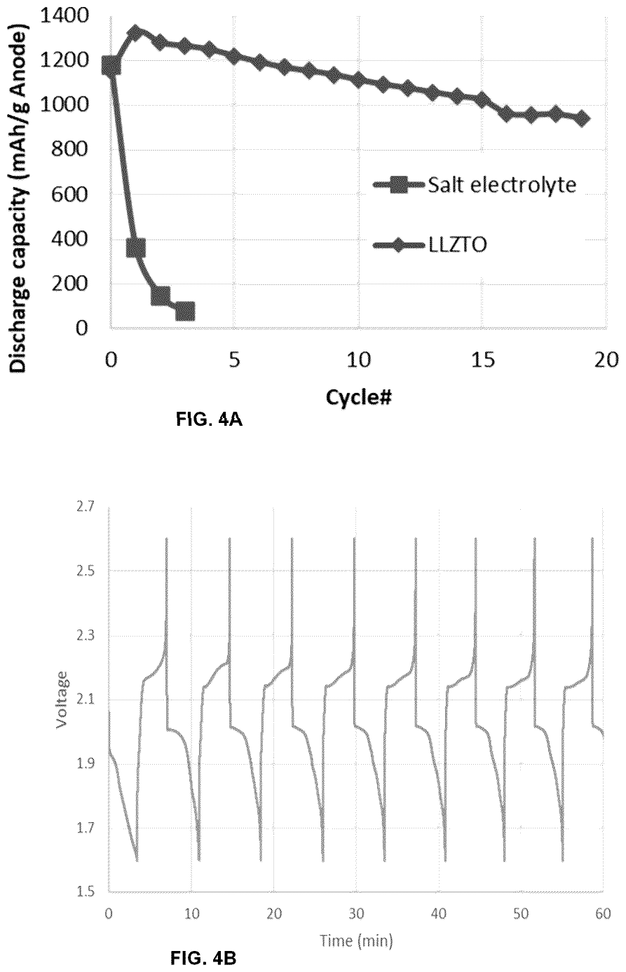

As shown in FIGS. 2B-2H and 3A-3D, the electrolytes 50A-50L of the primary active or electrical energy generation components 30B-30L includes solid or polymer electrolytes. The solid electrolytes may include at least ceramics including lithium containing garnets. Inclusion of the components 30B-30L in a thermal battery system 100 provides many advantages. A thermal battery system 100 including components 30B-30L according to the present invention may have a much lower capacity fade (about 2.5 times less) than a thermal battery employing only LiCl—KCl molten electrolyte bound in a non-lithium conductive filler including MgO. A thermal battery system 100 including components 30B-30L may enable the use of higher density anodes (e.g., a LiB anode that may have a density of about 100 mA/cm2 at about 500 °C). Systems 100 including the components 30B-30L may also have no vapor pressure at any appreciable temperature, modest ionic conductivity at room temperature that increases with higher temperature where the temperature response profile may be tailorable in an embodiment, wide electrochemical stability, no potential for solubility, and high mechanical stability. Further, systems 100 including the components 30B-30L may also be rechargeable for a period of cycles such as shown in FIGS. 4A and 4B using a process of intercalation such as shown in FIG. 1B.

In embodiments shown in FIGS. 2B-2F and 3A-3D, the electrolytes may include at least solid ceramics including lithium garnet Li₇La₃Zr₂O₁₂ (LLZO) and variants such as LLNO (Li₅La₃Nb₂O₁₂), LLTO (Li₅La₃Ta₂O₁₂), Li_{6.4}La₃Zr_{1.4}Ta_{0.6}O₁₂ (LLZTO) (FIGS. 2B-2F and 3A-3D). In an embodiment, an anode may at least include Li(Si) (FIGS. 2B-2E, 2G, and 2H). In an embodiment, a cathode may include at least FeS₂ (FIGS. 2B-2E, 2G, 2H, and 3A-3C). The anodes 40F and 40I of active components 30F and 30I may include a Li-metal, Li—B, or Li in an iron matrix (FIGS. 2F and 3A-3D). The cathodes 60F of active components 30F may include oxide-based materials including LiMnO₂ (FIG. 2F). The electrode 50H of active components 30H may include a lithium conducting polymer 54H separated from the anode 40H and cathode 60H by a non-ion conducting polymer (FIG. 2H). The different anodes, cathodes, and other electrolytes in conjunction with the solid electrolytes in the embodiments shown in FIGS. 2B-2H and 3A-3D, may provide various additional advantages and tradeoffs. For example, cathode 60J may include a combination of FeS₂ and LiCl—KCl and cathode 60K may include a combination of FeS₂ and LLZTO. In another embodiment 30L, a cathode may include cobalt disulfide (CoS₂).

FIG. 2B is a simplified diagram of a combination of primary active components 30B of a battery system 100 in accordance with one or more embodiments of the present invention. As shown in FIG. 2B, the primary active components 30B include an anode 40B consisting primarily of Li(Si), a cathode 60B consisting primarily of FeS₂, and a separator/electrolyte 50B between 40B and 60B consisting primarily of LLZTO—Li_{6.4}La₃Zr_{1.4}Ta_{0.6}O₁₂. A battery 100 including such primary components 30B may be considered a dry cell and have the high energy density. A battery 100 including the primary components 30B may also have high interfacial resistance between the components 40B-60B. It is noted that other Lithium garnets may be used on the electrolyte 50B including Li₇₋₃ₓAlₓLa₃Zr₂O₁₂ and Li₅La₃M₂O₁₂, for example. A battery 100 including such primary components 30B may be rechargeable using the following chemistry in an embodiment:

FeS₂+xLi⁺+xe⁻→LiₓFeS₂ (0<x<2, 1.5-1.7 V) Intercalation:

LiₓFeS₂+(4−x)Li⁺+(4−x)e⁻→Fe+2Li₂S (~1.5V). Conversion:

FIG. 1B is a simplified schematic 200B of a Li/FeS₂ rechargeable thermal battery 30I with a LLZO solid state electrolyte separator 50I in accordance with one or more embodiments of the present invention may be employed. During a charging state, energy (1.5-1.7 volts) may be applied to the battery 30I to cause Li+ ions to be intercalated with FeS₂ to form LiₓFeS₂. During a discharging state, energy (~1.5) may be supplied by the battery 30I to cause Li+ ions to be converted back to 2Li₂B. In an embodiment, the anode 40I may be in a molten forming a liquid anode (LAN).

In an embodiment shown in FIG. 3A-3D, the anode 40I may include Li-Metal, LiB, or LiFe matrix. Such an anode 40I may have a free metallic lithium phase supported by solid matrix improving rechargeability in an embodiment. FIG. 4A is a graph of discharged cell capacity at 450 °C for a rechargeable thermal battery configuration LiB/LLZTO/FeS2+LiCl—KCl such as a 30J configuration/combination (blue) shown in FIG. 3B compared to a conventional thermal battery cell with a molten salt electrolyte (green) in accordance with one or more embodiments of the present invention. As shown in FIG. 4A, configuration 30I still has over 75% of initial discharge capacity after 20 cycles during testing. FIG. 4B is a voltage plot of multiple cycles for a rechargeable thermal battery configuration such as 30J having a tantalum-doped LLZO sintered pellet separator with charge and discharge at 200 mA/cm² in accordance with one or more embodiments of the present invention.

In an embodiment, the anodes 40I-40L may be formed LiB foil where such a thinner material may provide increased energy density and capacity. Further, the anodes 40I-40L may have a lower battery activation temperature given Li melts at 180 °C. In such an embodiment, configurations 30I-30K may be activated without igniting an integrated heat source 10A, 10B. As shown in FIGS. 3B and 3C, cathodes 60J, 60K of configurations 30J, 30K may include FeS₂ combined with LiCl—KCl or LLZTO. As shown in FIG. 3D, a cathode 60L of configuration 30L may include cobalt disulfide (CoS₂).

In an embodiment, a tantalum-doped LLZO separator 50I-50K may be formed using a sintering process. In such a process, over-sized pellets of tantalum-doped LLZO may be pressed (at 10 kpsi in embodiment). The pressed pellets may be sintered at 1250 °C in MgO crucibles with mother powder. Then, any remaining mother powder may be removed, and the pellets may be polished to a desired final thickness.

FIG. 2C is a simplified diagram of another combination of primary active components 30C of a battery system 100 in accordance with one or more embodiments of the present invention that may be rechargeable. As shown in FIG. 2C, the primary active components 30C include an anode 40C consisting primarily of Li(Si), a cathode 60C consisting primarily of FeS₂, similar to 30B but includes a separator/electrolyte 50C between 40C and 60C consisting of a solid electrolyte 54C between two wet electrolytes 52C, 56C. The solid electrolyte 54C may consist primarily of LLZTO. The wet electrolytes 52C, 56C may be salts and consist primarily of LiCl—KCl. In an embodiment, the wet electrolytes 52C, 56C may be oxide based and melt at lower temperatures than molten-salt based thermal batteries employing different salts. A battery 100 including such primary components 30C may be considered to have wetter interfaces, low interfacial resistances, higher energy density than catholyte/anolyte designs and no self-discharge reactions. A battery 100 including the primary components 30C may, however, only function at temperatures above the melting temperature of salts 52C, 56C and have a tortuous path in anode and cathode resulting in underutilization of activate materials and higher internal resistance.

FIG. 2D is a simplified diagram of a further combination of primary active components 30D of a battery system 100 that may be rechargeable in accordance with one or more embodiments of the present invention. As shown in FIG. 2D, the primary active components 30D include an anode 40D consisting primarily of Li(Si), a cathode 60D consisting primarily of FeS₂, and a separator/electrolyte 50D between 40D and 60D consisting primarily of a mixture of LLZTO and LiCl—KCl. A battery 100 including such primary components 30D may operate like conventional thermal batteries but without the complexity of microstructural and nanostructural engineering of MgO. A battery 100 including the primary components 30D may, however, only function above the melting temperatures of salts in 50D, have self-discharge reactions with molten salt, and the formation of an electrolyte LLZTO+LiCl—KCl may require specialized micro-scale engineering.

FIG. 2E is a simplified diagram of a combination of primary active components 30E of a battery system 100 that may be rechargeable in accordance with one or more embodiments of the present invention. As shown in FIG. 2E, the primary active components 30E include an anode 40E consisting primarily of a mixture Li(Si) and a salt—a LiCl—KCl, a cathode 60E consisting primarily of a mixture FeS₂ and a salt—a LiCl—KCl, and a separator/electrolyte 50E between 40E and 60E consisting primarily of a solid electrolyte-LLZTO. A battery 100 including such primary components 30E may have low interfacial resistances, higher usage of active material, and repeatability. A battery 100 including the primary components 30E may, however, only function above the melting temperatures of salts in 40E, 60E and have lower energy density due to the salts in anode 40E and cathode 60E.

The respective dimensions (height and diameter where components 40E-60E are cylindrical) may vary on the desired capacity of battery system 100 incorporating the components 30E. For example, in a battery system 100 having a capacity of 45.5 mAh, the components 40E-60E may have diameters of about 9.6 mm. The anode component 40E may be about 508 microns thick and have a mass of 38.1 mg. The cathode component 60E may be about 522 microns thick and have a mass of 105.9 mg. The separator component 50E may be about 373 microns thick and have a mass of 141.9 mg. In another embodiment, the separator component may have a thickness in hundreds of nanometers. The cathode 60E may be 5% salt by mass and the anode 40E may be 15% salt by mass.

FIG. 2F is a simplified diagram of a combination of primary active components 30F of a battery system 100 that may be rechargeable in accordance with one or more embodiments of the present invention. As shown in FIG. 2F, the primary active components 30F include an anode 40F consisting primarily of Li-metals including Li—B and Li in an iron matrix, a cathode 60F consisting primarily of a lithium oxide including LiMnO₂, and a separator/electrolyte 50F between 40F and 60F consisting primarily of LLZTO. A battery 100 including such primary components 30F may be considered an oxide cell and have higher voltage, uses more common battery materials, operate at a lower temperature, and may be rechargeable. A battery 100 including the primary components 30F may have, however, lower energy densities than cathodes consisting primarily of FeS₂.

FIG. 2G is a simplified diagram of a combination of primary active components 30G of a battery system 100 that may be rechargeable in accordance with one or more embodiments of the present invention. As shown in FIG. 2G, the primary active components 30G include an anode 40G consisting primarily of a mixture Li(Si) and a Li-ion conducting polymer, a cathode 60G consisting primarily of a mixture FeS₂ and a Li-ion conducting polymer and a separator/electrolyte 50G between 40G and 60G consisting primarily of a lithium conducting polymer. The polymer used in these components may include Polyethylene-oxide (PEO) where the polymer may be selected based on a desired operational temperature profile of the resultant battery in an embodiment. The lithium conducting polymer may include PEO—LiTFSI and PEO—LiTFSI-LLZTO composite electrolytes. A battery 100 including such primary components 30G may have a lower melting temperature and thus operating temperatures than systems 100 employing molten salts and be more easily manufactured than systems 100 including LLZTO or molten salt. A battery 100 including the primary components 30G may, however, overheat and degrade and have a lower rate capability versus systems 100 employing molten salts.

FIG. 2H is a simplified diagram of a combination of primary active components 30H of a battery system 100 that may be rechargeable in accordance with one or more embodiments of the present invention. As shown in FIG. 2H, the primary active components 30H include an anode 40H consisting primarily of Li(Si), a cathode 60H consisting primarily of FeS₂, similar to 30B but including a separator/electrolyte 50H between 40H and 60H consisting of a lithium conducting polymer 54H between two non-ion conducting polymers 52H, 56H. It is noted that non-ion conducting polymers become conductive at operating temperatures due to their interaction with a lithium conducting polymer 54H. Other configurations of polymers 54H and non-ion polymers 52H, 56H are possible in embodiments. The polymer used in these components may include Polyethylene-oxide (PEO). The lithium conducting polymer may include PEO—LiTFSI and PEO—LiTFSI-LLZTO composite electrolytes. A battery 100 including such primary components 30H may have a lower melting temperature and thus operating temperatures lower than systems 100 employing molten salts, be more easily manufactured than systems 100 including LLZTO or molten salt and have increased storage times without self-discharge reactions. A battery 100 including the primary components 30H may, however, have lower power capabilities, slightly lower energy densities, and a higher propensity for self-discharge reactions than some configurations.

The invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. A rechargeable thermal battery system including:
a lithium based anode;
a lithium garnet based separator; and
an iron disulfide based cathode.

2. The rechargeable thermal battery system according to claim 1, wherein the lithium garnet separator consists primarily of one of Li₇La₃Zr₂O₁₂ and Li_{6.4}La₃Zr_{1.4}Ta_{0.6}O₁₂ (LLZTO).

3. The rechargeable thermal battery system according to claim 1, wherein the separator consists primarily of Li_{6.4}La₃Zr_{1.4}Ta_{0.6}O₁₂ (LLZTO).

4. The rechargeable thermal battery system according to claim 1, wherein the anode consists primarily of one of Lithium metal matrix, LiB, LiSi, and LiFe.

5. The rechargeable thermal battery system according to claim 1, wherein the anode consists primarily of LiB.

6. The rechargeable thermal battery system according to claim 1, wherein the cathode consists primarily of one of FeS₂, FeS₂+LiCl—KCl LiFe, FeS₂+LLZTO, and CoS₂.

7. The rechargeable thermal battery system according to claim 2, wherein the anode consists primarily of LiB.

8. The rechargeable thermal battery system according to claim 2, wherein the cathode consists primarily of FeS₂.

9. The rechargeable thermal battery system according to claim 3, wherein the anode consists primarily of one of Lithium metal matrix, LiB, LiSi, and LiFe.

10. The rechargeable thermal battery system according to claim 3, wherein the anode consists primarily of LiB.

11. The rechargeable thermal battery system according to claim 3, wherein the cathode consists primarily of one of FeS₂, FeS₂+LiCl—KCl LiFe, FeS₂+LLZTO, and CoS₂.

12. The rechargeable thermal battery system according to claim 3, wherein the cathode consists primarily of FeS₂.

13. The rechargeable thermal battery system according to claim 7, wherein the anode becomes substantially liquid when in operation.

14. The rechargeable thermal battery system according to claim 10, wherein the anode becomes substantially liquid when in operation.

15. The rechargeable thermal battery system according to claim 1, further including a heat source.

16. The rechargeable thermal battery system according to claim 1, wherein the separator is formed in part via sintering.

17. The rechargeable thermal battery system according to claim 7, wherein the separator is formed in part via sintering.

18. The rechargeable thermal battery system according to claim 10, wherein the separator is formed in part via sintering.

19. The rechargeable thermal battery system according to claim 7, wherein the anode is formed from LiB foil.

20. The rechargeable thermal battery system according to claim 10, wherein the anode is formed from LiB foil.
